(19) United States
(12) Patent Application Publication
(10) Pub. No.: US 2013/0057695 A1
(43) Pub. Date: Mar. 7, 2013

(54) METHOD AND APPARATUS FOR UNLOCKING/LOCKING A DOOR AND ENABLING TWO-WAY COMMUNICATIONS WITH A DOOR SECURITY SYSTEM VIA A SMART PHONE

(71) Applicant: Timothy J. Huisking, Costa Mesa, CA (US)

(72) Inventor: Timothy J. Huisking, Costa Mesa, CA (US)

(21) Appl. No.: 13/606,690

(22) Filed: Sep. 7, 2012

Related U.S. Application Data
(60) Provisional application No. 61/531,924, filed on Sep. 7, 2011.

(51) Int. Cl. H04N 7/18

(52) U.S. Cl. 348/156; 348/E07.085

(57) ABSTRACT

A method for operating a doorbell security system. The method may include receiving a doorbell press event signal and sending a doorbell press event notification to at least one mobile computing device. The method may further include receiving an acceptance response from a particular mobile computing device, wherein the acceptance response. The method may include receiving audio from a microphone and video from a camera located in proximity to a doorbell. The method may also include sending the audio from the microphone and the video from the camera to the particular mobile computing device. The method may additionally include receiving a command from the mobile computing device and unlocking, locking, opening, or closing a door.

### CROSS-REFERENCE TO RELATED APPLICATIONS

The present application claims the benefit under 35 U.S.C. §119(e) of United States Provisional Application Ser. No. 61/531,924 filed Sep. 7, 2011. U.S. Provisional Application Ser. No. 61/531,924 is herein incorporated by reference in its entirety.

### FIELD OF THE INVENTION

The present invention is directed generally toward a system and method of enabling a user to receive doorbell notifications, communicate with a visitor, and unlock a door via a mobile computing device.

### BACKGROUND OF THE INVENTION

Currently, doorbell security systems have limited audio and video capabilities. Doorbell security systems allow a user/resident to determine who is at the door without physically going to the door. Current doorbell security systems are usually implemented as a local system of a residence such that a user may only view or hear a guest at the door if the user is located in front of a video phone device located on the premises. Current doorbell security systems further lack the capability to handle real-time two-way audio and one-way video between a visitor and a user of a mobile device over mobile phone networks. Additionally, significant unresolved latency problems exist for communicating real-time two-way audio and one-way video between a doorbell intercom and a mobile computing device.

Therefore, it may be desirable to provide a method and apparatus which address the above-referenced problems.

### SUMMARY OF THE INVENTION

Accordingly, a method and related system are included for operating a door bell security system. The method may include receiving a doorbell press event signal; sending a doorbell press event notification to at least one mobile computing device; receiving an acceptance response from a particular mobile computing device of the at least one mobile computing device, the acceptance response indicating that a user of the particular mobile device has requested to receive at least one of audio of a microphone or video of a camera, wherein the microphone is located in proximity to a doorbell and the camera is located in proximity to the doorbell; receiving audio from the microphone located in proximity to the doorbell; receiving video from the camera located in proximity to the doorbell; sending at least one of the audio from the microphone located in proximity to the doorbell or the video from the camera located in proximity to the doorbell to the particular mobile computing device upon receiving the acceptance response from the particular mobile computing device; receiving a command from the mobile computing device; and performing an action upon receiving the command from the mobile computing device.

A further doorbell security system embodiment may comprise a doorbell security system board configured for: receiving a doorbell press event signal; sending a doorbell press event notification to at least one mobile computing device; receiving an acceptance response from a particular mobile computing device of the at least one mobile computing device, the acceptance response indicating that a user of the particular mobile device has requested to receive audio of a microphone and video of a camera, wherein the microphone is located in proximity to the doorbell and the camera is located in proximity to the doorbell; establishing a two-way audio channel via an SIP (session initiation protocol) connection through an SIP server, wherein the SIP server runs on another mobile computing device between the particular mobile computing device and the doorbell security system board; receiving audio from the microphone located in proximity to the doorbell; receiving video from the camera located in proximity to the doorbell; sending the audio from the microphone located in proximity to the doorbell to the particular mobile computing device upon receiving the acceptance response from the particular mobile computing device; sending the video from the camera located in proximity to the doorbell to the particular mobile computing device upon receiving the acceptance response from the particular mobile computing device; receiving audio from the particular mobile computing device; and sending audio from the particular mobile computing device to a speaker located in proximity to the doorbell; receiving a command from the mobile computing device; and sending at least one signal to at least one relay configured to activate at least one of a door lock mechanism or a door opener/closer mechanism upon receiving the command from the particular mobile computing device, wherein the door lock mechanism is configured to unlock or lock a door and the door opener/closer mechanism is configured to open or close the door, wherein audio and video is configured to be communicated substantially in real-time.

It is to be understood that both the foregoing general description and the following detailed description are exemplary and explanatory only and are not restrictive of the invention claimed. The accompanying drawings, which are incorporated in and constitute a part of the specification, illustrate embodiments of the invention and together with the general description, serve to explain the principles.

### BRIEF DESCRIPTION OF THE DRAWINGS

The numerous objects and advantages of the present invention may be better understood by those skilled in the art by reference to the accompanying figures in which:

FIG. 1 shows a diagram of an audio/video door phone system;

FIG. 2 shows a diagram of a doorbell security system;

FIG. 3 shows a suitable system architecture diagram associated with embodiments of the doorbell security system;

FIG. 4 shows a block diagram of a suitable configuration of electronic components of a doorbell security system board;

FIG. 5 shows a block diagram of suitable firmware architecture associated with the doorbell security system and a server;

FIG. 6 shows a diagrammatic view of a screen displaying a doorbell notification;

FIG. 7 shows a diagrammatic view of a door security system application running on a smartphone screen;

FIG. 8 shows a suitable software architecture diagram of an embodiment configured to support iOS 4;

FIG. 9 shows a suitable software architecture diagram of an embodiment configured to support iOS 3;

FIG. 10 shows a suitable software architecture diagram of an embodiment configured to support Android;

FIG. 11 shows a suitable software architecture diagram of an embodiment configured to support third party devices;

FIG. 12 shows a diagram of a notification system for an iPhone 3 platform;

FIG. 13 shows a diagram of a device communicating 1500 with an APNS server;

FIG. 14 shows a further diagram of a device communicating 1500 with an APNS server;

FIG. 15 shows an additional diagram of a device communicating 1500 with an APNS server;

FIG. 16 shows a diagram of a secured token communication; and

FIG. 17 shows an embodied method for operating a doorbell security system.

### DETAILED DESCRIPTION OF THE INVENTION

Embodiments of the invention may include a doorbell security system configured to send a user doorbell notifications on a mobile computing device (such as a smartphone (e.g., an iPhone, Android-based phone, or the like), a tablet computing device (e.g., an iPad, Android-based tablet, or the like), or the like) which may be connected to the internet. The doorbell security system can be configured to establish communication between a guest at a door and a user of a mobile computing device with two-way audio and one-way/two-way video. The doorbell security system can be configured to unlock or lock the door by sending a signal to activate a relay configured to activate or power an unlock/lock mechanism (such as an electrical or motorized unlock/lock mechanism). The doorbell security system can be configured to open or close a door by sending a signal to activate a relay configured to activate or power a door opener/closer mechanism (such as an electrical or motorized door opener/closer mechanism). The doorbell security system may allow the user to receive doorbell call events, establish audio/video communication with the visitor, and control door entry by activating or deactivating relays, relay contacts, contactors, or the like.

Embodiments of the invention may include a doorbell security system, a door lock application configured to run on a mobile computing device (such as a smart phone), a method, and a device. A doorbell security system may allow the user to control door operation remotely. The doorbell security system product can replace an existing door lock entry system, whereby the existing door lock entry system requires operation from inside the home. Implementations of the invention can use existing analog video, analog audio lines, cameras, analog audio speakers, or other equipment.

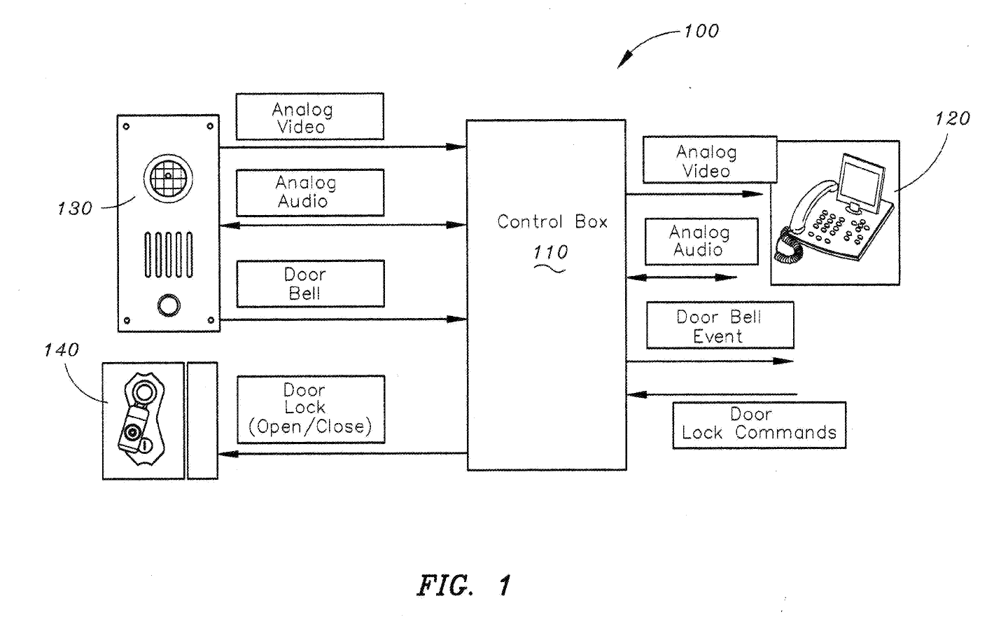

Referring to FIG. 1, a diagram of an audio/video door phone system 100 (such as a Holovision door phone system) is depicted. The video door phone may process doorbell events (such as a visitor pressing the doorbell) and alert the home owner through an audio ring of the doorbell event. When the home owner responds to the ring (e.g., by pressing a button on the video phone or by picking up the handset of a video phone), a session may be established with the visitor. The home owner may communicate with visitor through audio and may view video of the visitor. After verifying authenticity of the visitor, the home owner may issue a door open or unlock command from the device, whereby the command, for example, is configured to unlock or open the door.

The audio/video door phone system may include a control box 110, one or more video phones 120, one or more doorbells 130, one or more relays, and one or more door locks 140.

The control box 110 may include a processor, memory, storage, one or more controllers (such as an audio controller, a video controller, or the like), wireless transmitter/receiver, other computer hardware, software, firmware, or the like. The control box 110 may be communicatively coupled to the one or more video phones 120, the one or more doorbells 130, the one or more relays, and the one or more door locks 140.

Each doorbell 130 may comprise an audio/video intercom doorbell. An audio/video intercom doorbell can include a camera, a microphone, a speaker, and one or more doorbell user interfaces (such as a button, a touchscreen, or the like). Each doorbell 130 may be communicatively coupled to the control box 110.

Each video phone 120 may be configured to allow communication between a user of the video phone 120 and a visitor at the audio/video intercom doorbell. The video phone 120 may further include a display configured for viewing video captured by the camera of the audio/video intercom doorbell, a speaker for playing audio captured by the microphone of the audio/video intercom doorbell, and a microphone configured to capture or record audio from a user of the video phone 120.

Each door or door lock 140 can be configured such that the control box (in response to a signal or command received from the video phone) can open or close the door by sending a signal to activate a relay configured to activate or power a door opener/closer mechanism (such as an electrical or motorized door opener/closer mechanism). Each door or door lock 140 can further be configured such that the control box (in response to a signal or command received from the video phone) can unlock or lock the door by sending a signal to activate a relay configured to activate or power an unlock/lock mechanism (such as an electrical or motorized unlock/lock mechanism).

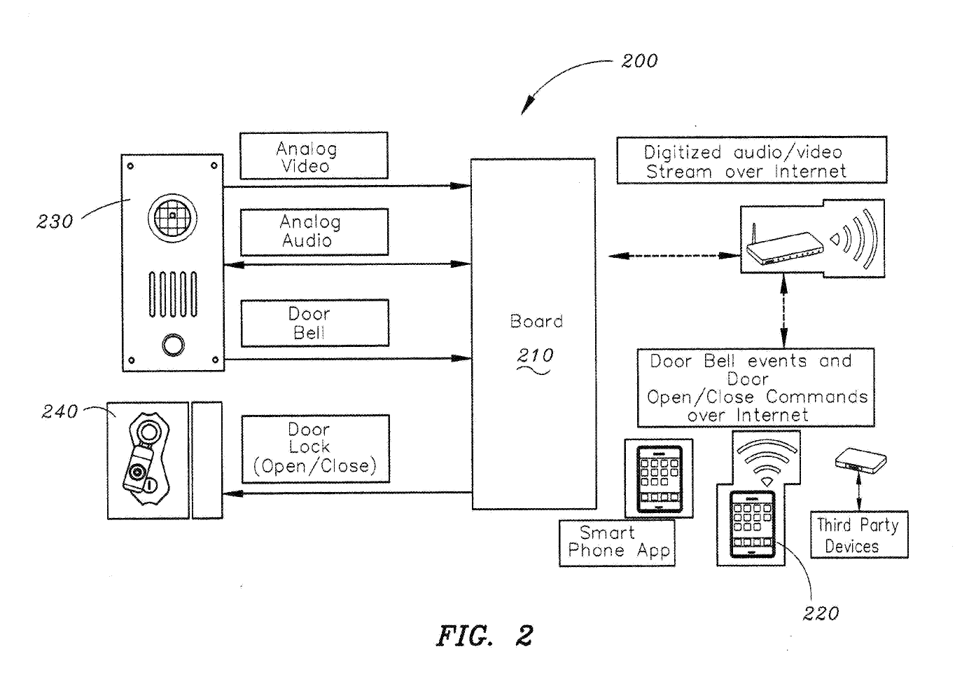

Referring to FIG. 2, a diagram of an embodiment of a doorbell security system 200 is depicted. Some embodiments of the doorbell security system 200 may include a product, device, control box, or board 210 configured to allow a user to unlock, lock, open, or close a door or door lock 240 remotely from an application hosted on a mobile computing device platform 220 (such as a smartphone or tablet computing device). The product, device, control box, or board 210 may process the doorbell button press event received from a doorbell 230 and connect the visitor to a registered smart phone/mobile computing device user (e.g., the home owner) over an internet/Ethernet link, upon the occurrence of the event.

The doorbell security system 200 may include a product, device, control box, or board 210; one or more mobile computing devices 220 (such as one or more smart phones, tablet computing devices, or the like); one or more doorbells 230; one or more relays; one or more doors or door locks 240; one or more components of a particular audio/video door phone system 100; or the like.

The product, device, control box, or board 210 may include a processor, memory, storage, one or more controllers (such as an audio controller, a video controller, or the like), wireless transmitter/receiver, one or more storage mediums (such as one or more hard drives, solid state drives), one or more removable storage mediums (such as one or more removable flash cards or the like), memory (such as RAM (random access memory) or the like), one or more data ports, one or more user-interfaces (such as buttons or the like), one or more batteries, one or more power ports, other computer hardware, software, firmware, or the like. The product, device, control box, or board 210 may be communicatively coupled to the one or more mobile computing devices 220, one or more doorbells 230, one or more relays, one or more doors or door locks 240, one or more components of a particular audio/video door phone system 100, or the like.

Each doorbell 230 may comprise an audio/video intercom doorbell. An audio/video intercom doorbell can include a camera, a microphone, a speaker, and one or more doorbell user interfaces (such as a button, a touchscreen, or the like). Each audio/video intercom doorbell may be configured to send and/or receive analog or digital audio or video signals or streams. Each doorbell 230 may be communicatively coupled to the product, device, control box, or board 210.

The one or more mobile computing devices 220 may include one or more smart phones, tablet computing devices, or the like. Each mobile computing device may be configured to communicate with the product, device, control box, or board 210 such that a user of the mobile computing device 220 can communicate with or receive audio and/or video of a visitor in proximity to a particular doorbell 230. Each mobile computing device 220 may be configured to receive real-time audio and/or real-time video from the particular doorbell 230 and send real-time audio and/or video to the particular doorbell 230. Each mobile computing device 220 may be configured to receive doorbell event notifications, such as a notification that a doorbell 230 has been pressed. Each mobile computing device 220 may further be configured to send commands (such as commands to unlock, lock, open, or close a door, to ignore the doorbell or visitor, to activate or deactivate the door security system 200, to enable or disable particular mobile computing devices from accessing or interacting with the doorbell security system 200, or the like) to the product, device, control box, or board 210. Each mobile computing device 230 may include an application running on the mobile computing device 230 configured for executing code to perform functions described herein.

Each mobile computing device 220 may be configured to communicate wirelessly via a wireless network or communicate with wires via a wired network. Each mobile computing device 220 may include a display (such as an LCD (liquid crystal display) display or LCD touch-screen display), one or more cameras, one or more microphones, one or more speakers, one or more processors, one or more transmitter/receivers, one or more storage mediums (such as one or more hard drives, solid state drives), one or more removable storage mediums (such as one or more removable flash cards or the like), memory (such as RAM (random access memory) or the like), one or more data ports, one or more user-interfaces (such as buttons or the like), one or more batteries, one or more power ports, other computer hardware, software, firmware, or the like.

Each door or door lock 240 can be configured such that the product, device, control box, or board 210 (in response to a signal or command received from a particular mobile computing device) can open or close the door by sending a signal to activate a relay configured to activate or power a door opener/closer mechanism (such as an electrical or motorized door opener/closer mechanism). Each door or door lock 240 can further be configured such that the product, device, control box, or board 210 (in response to a signal or command received from a particular mobile computing device) can unlock or lock the door by sending a signal to activate a relay configured to activate or power an unlock/lock mechanism (such as an electrical or motorized unlock/lock mechanism).

The product, device, control box, or board 210 may utilize existing analog audio and/or video, and then digitize and compress the analog audio and/or video (using standard encoders/decoders) and transmit the digitized and/or compressed audio and video over a network connection such as a TCP/IP (Internet) link. The doorbell security system 200 can establish or enable real-time or substantially real-time bi-directional audio communication between the visitor at the doorbell 230 and the user of the mobile computing device 230 (such as a smart phone). In some implementations, the doorbell security system 200 may allow only uni-directional video communication from in front of the doorbell 230 to the recipient mobile computing device 220.

The product, device, control box, or board 210 can also handle action commands (Open Door/Close Door) received from a user of a mobile computing device 220 (such as smart phone). In response to receipt of a particular action command, the product, device, control box, or board 210 may, for example, perform door lock/unlock operations using electromechanical or mechanical relays (such as NC/NO (“normally closed/normally open”) relays or the like).

One doorbell unit 230 can be configured to connect to multiple recipient mobile computing devices 230 via the product, device, control box, or board 210 (and communication connections); however, in some implementations, only one recipient mobile computing device 220 will be permitted to communicate with doorbell 230 at any point in time. That is, one smart phone/device application may connect to multiple doorbell systems (such as a front door system and back door system) but may be configured to control only one door at a time.

All communications from the application of the mobile computing device 220 to the product, device, control box, or board 210 may be secured. Mobile computing devices 220 may be paired with the doorbell security system 200. Pairing of devices (doorbell unit and the allowed recipient mobile computing devices 220) may require authorization of applications running on mobile computing device platforms (such as smart phone platforms).

The doorbell unit 230 may be powered by Wired Ethernet (PoE) or 12 V DC regulated DC input. The user may have an option to choose which voltage source to use. The doorbell security system board 210 may be installed along with the doorbell unit such that the doorbell unit 230 is communicatively coupled with the doorbell security system board 210.

An application may be loaded or installed onto one or more mobile computing devices 220. The application may be configured to run on various mobile computing devices 220. For example, the application may be supported on Apple's iPhone (iOS4/iOS3) and iPad (iOS4) as well as devices running Google's Android operating system. Main parts of the operation of the system may include: the doorbell press event; one-way video transmission from the product, device, control box, or board 210 to the application of the mobile computing device 220; bi-directional audio communication; and transmission of the door lock/unlock command from the application of the mobile computing device 220 to the product, device, control box, or board 210.

The doorbell security system board 210 may be responsible for transmitting the doorbell press events to the associated mobile computing devices 220 such that the user is alerted or notified of the doorbell press events. The particular mobile computing device 220 or the application may be configured such that the user can choose to respond to the alert. Response to the alert can automatically invoke the application. Additionally, the user may choose to ignore the alert, wherein the application is not invoked.

Once the application is invoked, the user may be able to view the video (H.264, MJPEG) being captured by the camera installed with the doorbell unit in real-time or substantially real-time.

An audio channel may be established between the doorbell security system board 210 and the application facilitating two-way voice communication between the visitor at the door and the user of the mobile computing device 220. Suitable audio formats (e.g., 16-bit PCM, GSM-AMR, MC, G.711) available on all platforms may be used.

At any point during the conversation or when the application is running, the user of the mobile computing device 220 may have access to one or more actions or commands. For example, the user may be prompted to lock the door, unlock the door, or ignore the doorbell press event, or exit. These actions may be executed, for example, by clicking or pressing a button associated with the application on the screen of the mobile computing device 220. These actions or commands may be transmitted to the product, device, control box, or board 210 via a secure or unsecured channel, wherein, for example, the action(s) or command(s) are configured to lock or unlock the door using electromechanical or mechanical relays. Additional actions may include muting or disabling a microphone of the mobile computing device 220, muting or disabling a camera of the mobile computing device 220, or the like.

Embodiments of the invention may include or utilize electronics, software, firmware, applications of mobile computing devices 220, or the like.

A doorbell security system board 210 may be configured to handle digital and/or analog audio output from a microphone, analog and/or digital video output (such as NTSC/PAL composite video—RF modulated) from a camera, and a doorbell press signal (TTL voltage) from the doorbell. A doorbell security system board 210 may be configured for providing analog audio input to at least one speaker and may configured to generate lock/unlock door signals (through relay contacts). A doorbell security system board 210 can use suitable hardware configured to support generation of suitable video formats, such as H.264 and MJPEG. Suitable hardware may be configured to support additional video formats. The doorbell security system may be configured to minimize overall communication latency. Furthermore, overall communication latency from the doorbell security system board may be configured not to exceed a selected duration (e.g., 0.05 seconds, 0.5 seconds, 2 seconds, 10 seconds, or 30 seconds). The doorbell security system board 210 may be powered, for example, by Power on Ethernet (PoE) or 12V regulated DC.

Firmware or software of the doorbell security system 200 may be configured to provide a software API interface over TCP/IP link for third party products or applications to interface with the door lock or door unlock/lock mechanism. An exemplary application may include software running on iPhone/iPad/Android platform connected to doorbell security system 200 via the internet. The firmware or software may include a mobile computing device 220 application configured to transmit data over the internet link whenever the doorbell is pressed. Firmware or software may be configured for digitized video streams to be encoded according to suitable video compression standards, such as H.264, MJPEG, MJPEG-2, or the like. Firmware or software may be configured for digitized audio streams to be encoded as per standard file formats, such as MC, 16 bit PCM or GSM-AMR. Firmware or software may be configured to use analog audio and/or video output generated by an existing system, and then, digitize and encode multi-media data and stream the data over internet link. The firmware or software may be configured to receive audio from a mobile computing device application connected over the internet link and configured to process the audio. Firmware or software may be configured to receive commands (such as lock or unlock door commands) from a mobile computing device application connected over internet link. Firmware or software may be configured for notification and command control communication to be via a secured channel (such as SSL/TSL). Firmware or software may be configured for storing some or all video/audio communications such as for audit trail or log purposes. Firmware, software, and/or hardware may further support audio amplification of one or more signals. Hardware, software, and/or firmware may be configured to include a communication protocol configured to suppress ECHO. Firmware and/or software may be configured with one or more options to zoom, pan, tilt, or otherwise adjust a camera. Firmware and/or software may support storage of audio and/or video logs on associated platforms or storage associated with associated platforms.

One or more mobile computing device applications may be configured to interface with the doorbell security system 200. An application of the mobile computing device may use suitable or otherwise standard communication protocols such as HTTP, RTP/RTSP, UDP/IP, and/or TCP/IP over an internet link. The application may be configured for bi-directional audio communication between a mobile computing device user and the visitor. In some implementations, the application may permit only uni-directional video communication between the mobile computing device user and the visitor such that the mobile computing device user may view video of the visitor but the visitor cannot view video of the mobile computing device user. The application may be configured to process digitized video/audio stream sent from the doorbell security system 200 and display/play the same on the mobile computing device 220 screen. The application may also send digitized audio stream from the mobile computing device 220 to the visitor at the doorbell 230. The application may be configured with action or command buttons configured to perform actions on the doorbell security system 200. For example, an enable doorbell security system action button may be configured to enable the doorbell security system 200. The application may be supported on versions of mobile computing devices such as iPhones or iPads (Apple iOS) (e.g., versions of iOS3, 4 or 5, or later) and/or Google Android OS platforms (e.g., versions 2 or later), other operating systems, or similar platforms. The application may be protected with a password. The application may include registering/unregistering mechanisms with the doorbell security system board 210. The application may further include an option to mute audio output/input. The application may support storage of audio/video logs on associated platforms or storage associated with associated platforms.

The doorbell security system 200 or doorbell of the system 200 may include an integrated camera which may be configured for advanced control of video images.

Some embodiments of the doorbell security system may be configured such that only one mobile computing device 220 has an active connection with an associated doorbell unit at any point in time. In some implementations, some embodiments of the doorbell security system may be configured to allow multiple mobile computing devices to have an active connection with an associated doorbell unit at a point in time.

Some embodiments of the doorbell security system may be configured such that a doorbell press event is transmitted to multiple associated or registered mobile computing devices 220, wherein only a first device to respond can establish a connection with the doorbell security system 200. Other mobile computing devices may be blocked from connecting to the doorbell security system 200.

Some embodiments of the doorbell security system 200 may be configured such that a mobile computing device user may not be able to hand over or pass an established connection to another mobile computing device user.

Some embodiments of the doorbell security system 200 may be configured such that if a registered mobile computing device 220 is powered off or lacks network connectivity when an when a doorbell press event is transmitted, the failure of the mobile computing device 220 to receive the transmitted doorbell press event will be handled as a “no response.” The doorbell security system 200 may be configured such that if doorbell press events are raised simultaneously from multiple doorbell units 230 associated with the same registered mobile computing device, a particular doorbell press event of a particular doorbell 230 will take precedence and the other(s) may be ignored. The doorbell security system 200 may be configured to handle multiple doorbell press events from the same doorbell unit 230 within a pre-defined time range (for example, 2 seconds, 10 seconds, 30 seconds, 1 minute, or the like) as a single doorbell press event. The doorbell security system 200 may be further configured to ignore doorbell press events after a connection is established.

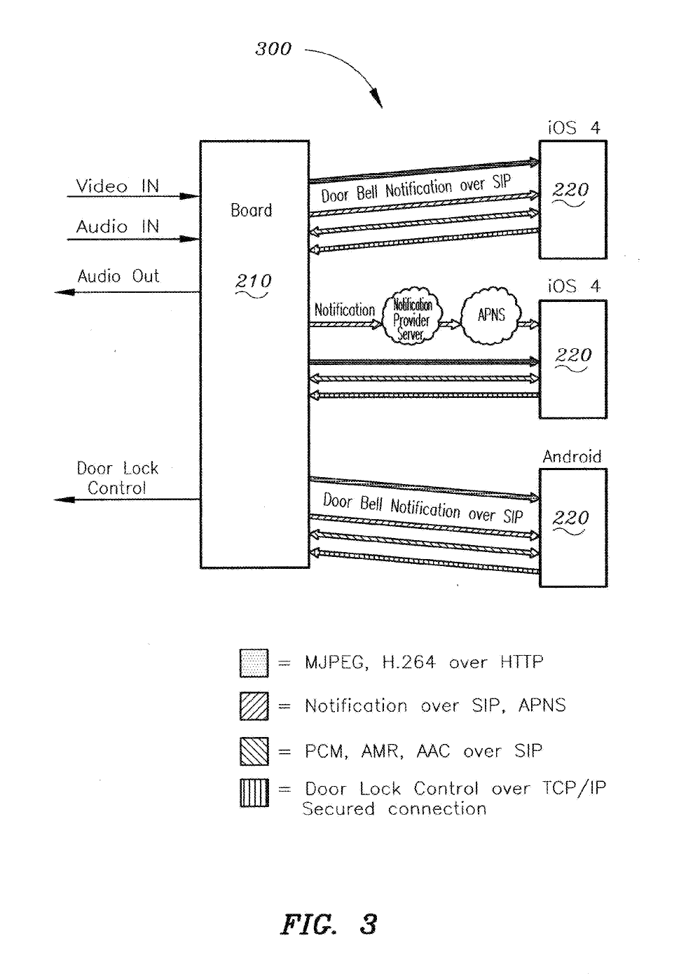

Referring to FIG. 3, a suitable system architecture 300 diagram associated with embodiments of the doorbell security system 200 is depicted. The overall architecture of a system is depicted in the figure above. Technical architecture may differ based on multi-tasking support available on various smartphone or mobile computing device platforms.

The doorbell security system 200 and/or application may be configured to run on mobile computing device platforms which support multi-tasking applications (such as iOS4/iPhone4, Android, or the like).

On mobile computing device platforms which support multi-tasking applications, at a time of application start-up, the application may initiate an audio session with the doorbell security system board 210 over an IP (internet protocol) link using SIP (Session Initiation Protocol) protocol. The application may run in background mode thus permitting a user to work on other applications. The board 210 may use this connection to send doorbell notifications since the protocol may allow bi-directional communication. The background application/OS (operating system) may listen on a VOIP (Voice Over IP) socket, and arrival of data packets on this socket may notify the user of the event. If the user acknowledges the event, then the background application/OS may close the foreground application (for example, on iOS4 platform) or the background application/OS may push one or more currently running foreground applications (for example, on an Android platform) to the background mode. Then the application may be brought to the foreground. The mobile computing device application may subsequently initiate an http (HyperText Transfer Protocol)/RTP (Realtime Transport Protocol) session with the board to download the video and may use the SIP connection for bi-directional audio communication. For sending the door lock/unlock commands, separate secured connection (SSL (Secure Sockets Layer)/TSL over IP) may be established between the application and the board 210. At the end of the session, the application may close a secured communication channel and/or video session. The SIP connection may remain active to receive subsequent notifications.

The application may be configured to run on mobile computing device platforms which do not support multi-tasking applications (e.g., iOS3/iPhone3).

On platforms which do not support multi-tasking (Background/Foreground applications) operations, a separate server based notification may be required to notify the mobile computing device application about a doorbell event. A secured communication channel may be established between 1) Service notification server (e.g., APNS (Apple Push Notification Service) server for iOS3 platforms) and a notification provider (such as a doorbell security system notification server (e.g., Holovision notification server)), 2) mobile computing device 220 (example: iOS3 phone) and a notification provider and 3) a mobile computing device 220 and an event notification server (such as APNS). When a doorbell event occurs, the board may send this event to a notification provider (e.g., Holovision notification server), wherein the notification provider and in turn may forward these notifications to the event notification server (e.g., APNS). The APNS, for example, may send the event to a registered mobile computing device 220, such as an iPhone3/iOS3 device. The event may be displayed on the mobile computing device 220.

If a user acknowledges the event, then the OS may bring up the doorbell security system application. The application may then initiate an http/RTP session with the board 210 to download the video and may use the SIP connection for bi-directional audio communication. For sending the door lock/unlock commands, separate secured connection (SSL/TSL over IP) may be established between the application and the board. At the end of session, the application may close the secured communication channel, video session, and SIP audio session.

Doorbell security system board 210 may include one or more processors. For example, the board 210 may include or be based on TI's (Texas Instrument's) DaVinci series processor. The doorbell security system board 210 may host an embedded Linux Operating System and open source Live Media Server. The processor 410 (e.g., TI's DaVinci series processor) may include a core (e.g., an ARM9 core) and a video sub processing unit configured to support video codec's such as H.264, MPEG4, and MJPEG.

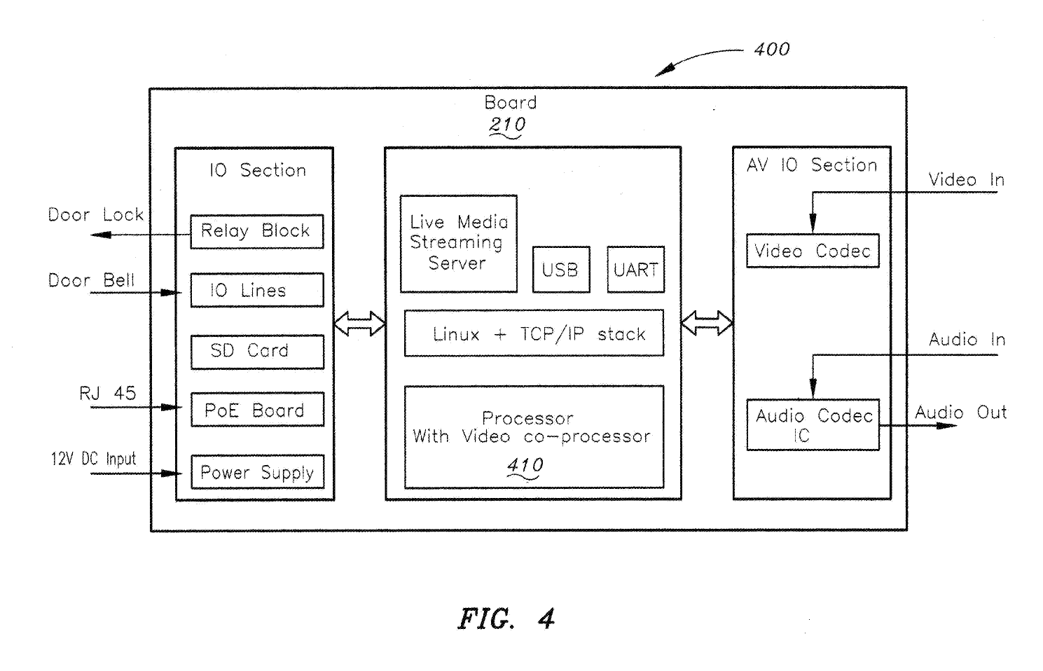

Referring to FIG. 4, a block diagram of a suitable configuration 500 of electronic components of a doorbell security system board 210 is depicted.

The processor 410 may include a video codec section. The video codec section may receive an external composite video signal (such as an NTSC/PAL (Phase Alternating Line) signal) through a connector (such as a BNC connector) and may provide the signal to the processor 410 in digital format (such as BT-656). Within the processor 410, an incoming video stream may be processed by the video processing sub unit and may be further provided to a core (e.g., an ARM core). The core (e.g., ARM) then may packetize the data, either as MJPEG images or H.264 video in RTP packets, which later may be sent through an Ethernet chip.

An audio codec section, integrated with processor through bi-directional 12S bus, may be configured for receiving audio input through a suitable interface and providing audio output to the mobile computing device 220 or the doorbell 230 through a suitable interface. Encoding and compression of audio may be performed inside the processor 410 in a suitable or required format. According to particular audio compression/encoding algorithms, sampling frequency and resolution may be adjusted in the codec IC (integrated circuit).

A door lock or door lock mechanism may be directly connected to doorbell security system board's relay output such that upon receiving a door unlock command, the relay may be energized to open the door. An isolated interface for connecting a doorbell 230 may be provided on the board.

The doorbell security system board 210 may include multiple power supply options, including a 12V (volt) DC (direct current) adapter and Power over Ethernet (PoE).

A removable storage slot (such as an SD (secure disk) memory card slot or the like) may be used to store transaction details or other data.

The doorbell security system board 210 components may include the following, suitable substitutes of the following, or functional equivalents of the following: an Rj-45 connector for 10/100 Ethernet port with PoE capability; a BNC connector for composite video; an audio input and output configured with suitable interfaces; a relay output for a door unlock mechanism; an SD memory card slot for expansion; a 12V power supply connector; and a doorbell input connector.

Contemplated embodiments of the present invention include firmware or software which may include a Live Media server which may run on an embedded Linux platform with support for MJPEG over http, H.264 over RTP/RTSP, SIP, and audio codecs. The firmware, software, or live media server may be configured for streaming H.264 over http for progressive download and may support HTTP Live streaming in a configuration supported on iOS 4 and iOS 3 platforms.

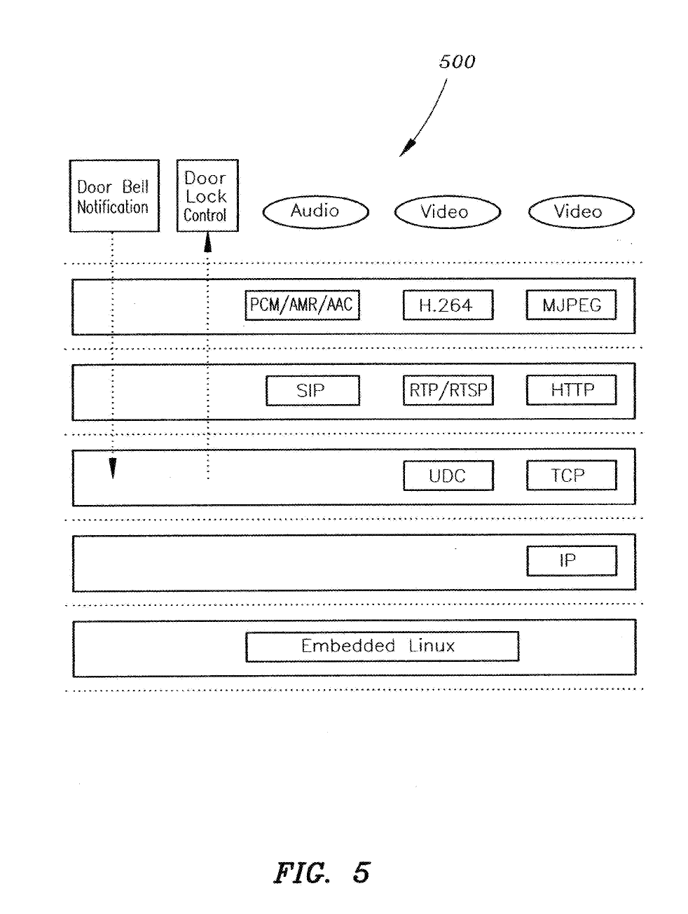

Referring to FIG. 5, a block diagram of suitable firmware architecture 500 associated with the doorbell security system 200 and a server is depicted.

The doorbell security system board 210 may include an embedded Linux kernel 2.6 as a base platform running on a core of the processor 410. For networking, the doorbell security system board 210 may use a Linux TCP (Transmission Control Protocol)/IP stack.

The Live Media server may include an open source C++ library for multimedia streaming, using protocols such as RTP/RTSP, HTTP, and SIP. Live media server may handle video and bi-directional audio streaming with a client application.

The video sub-processor may run algorithms to encode raw video into required video formats. Suitable methods of streaming video to a user may include: MJPEG over HTTP and H.264 RTP tunneling through HTTP. In MJPEG over HTTP, video may be transmitted as a series of JPEG images over HTTP. In this method each frame may be compressed using the JPEG algorithm and may be sent over the Ethernet. In H.264 RTP tunneling through HTTP, raw video may be compressed in H.264 format and may be packetized using an RTP protocol and may send it over the HTTP. H.264 may use inter frame compression technology, which requires less network bandwidth for the same image quality achieved for MJPEG.

Bi-directional audio communication may be established using SIP protocol, which may be included in a live media server library. The doorbell security system firmware may support suitable audio codecs, including: 16-bit PCM (Pulse Coded Modulation), AMR (Adaptive Multi-Rate), or AAC (Advanced Audio Coding). 16-bit PCM is an uncompressed audio format which requires less processor bandwidth for playback at the user side. AMR is an audio codec optimized for speech coding, which adjusts the bit rate according to the link conditions. AAC is a default audio format for some products and gives high quality audio at similar bit rates.

An application over a secured layer over TCP/IP on the processor core (e.g., ARM core) may handle doorbell event notification and may process a user request for video stream and a door unlock message. On reception of a doorbell trigger, a client application may be notified either through the direct connection between the doorbell security system board 210 and the mobile computing device 220 or through a back-end server mechanism. Once the user accepts a notification, the doorbell security system server may begin streaming video and establish a bi-directional audio link between the board 210 and the mobile computing device. The door lock/unlock command may be passed over a secured TCP/IP link between the two.

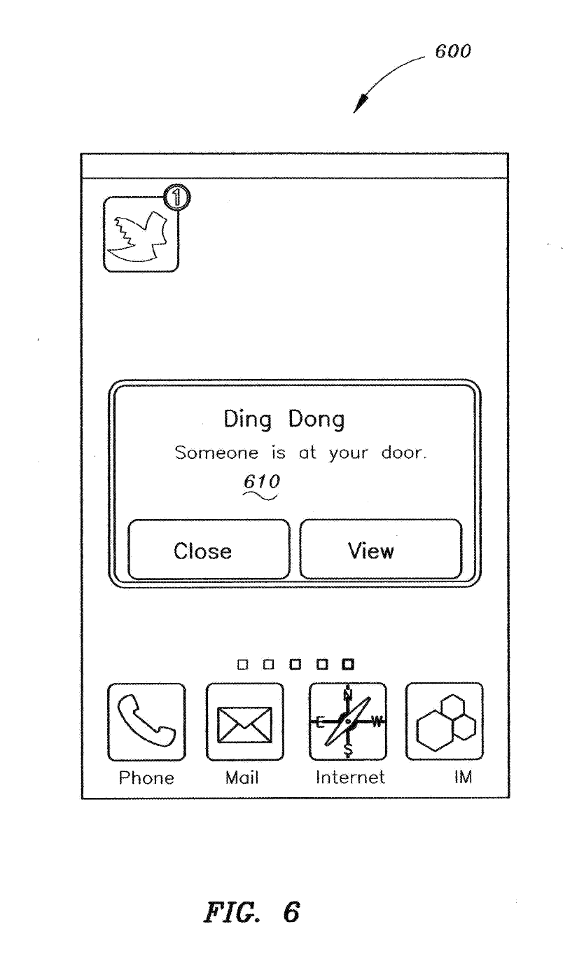

Referring specifically to FIG. 6, a diagrammatic view of a screen 600 displaying a doorbell notification 610 and a UI (user interface) (such as a GUI (graphical user interface)) on a smart phone platform is depicted.

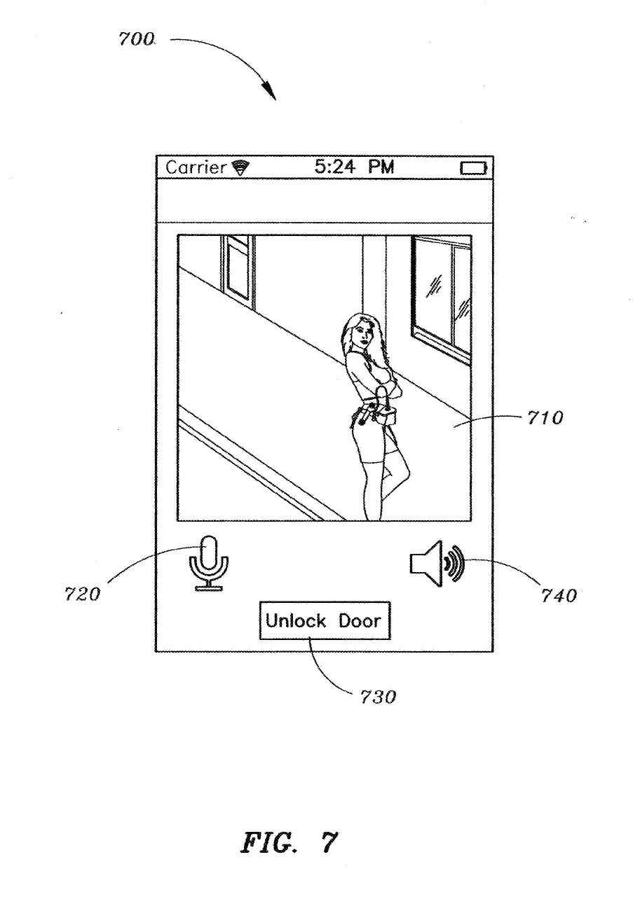

Referring to FIG. 7, a diagrammatic view of a door lock application running on a smartphone screen 700 is depicted. The application of a mobile computing device 220, such as a smart phone, may include one or more screens for a user to interact with. A screen may display information. For example, a square window may display real-time or substantially real-time video 710 from a doorbell unit camera and may be configured to occupy a majority of the screen space. For example, one or more action buttons 730 may be located below the video box which control the lock/unlock door operations. The screen may also display GUI buttons 720, 740 which can represent the microphone and the speaker and which can be configured to control the application's audio communications.

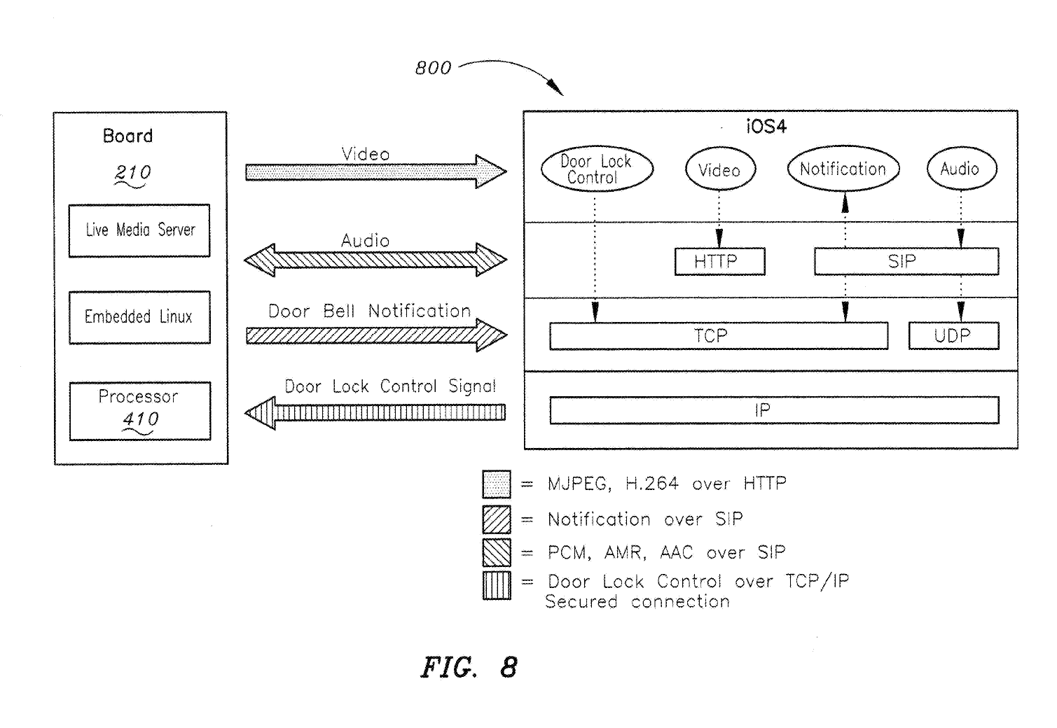

Referring to FIG. 8, a suitable software architecture 800 diagram of embodiments configured to support iOS4 is depicted. Embodiments of the present invention may include system architecture configured to support a native application on an iOS 4 mobile computing device. A doorbell press event notification may be transmitted as data over an SIP connection between the doorbell security system board 210 and a registered iOS 4 device 220. The SIP connection may be established when the registered mobile computing device 200 (installed with the application) is powered on. The video (e.g., in H.264 or MJPEG format) may be transmitted over HTTP from the board 210 to the registered iOS 4 mobile computing device 220. The audio (e.g., in 16-bit PCM, AMR or AAC formats) communication between the board 210 and the registered iOS 4 mobile computing device 200 may be established by SIP. The iOS 4 device may send a control signal or command to lock/unlock the door by transmitting data securely over TCP/IP to the board 210.

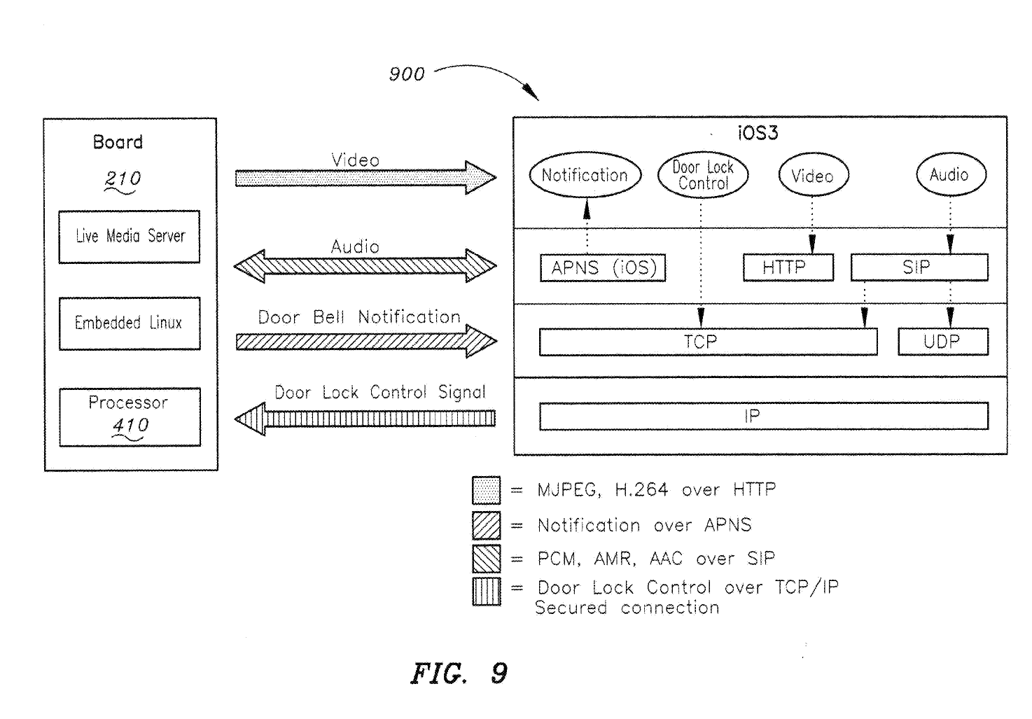

Referring to FIG. 9, a suitable software architecture 900 diagram of embodiments of the present invention configured to support iOS3 is depicted. Embodiments of the present invention may include system architecture configured to support a native application on iOS 3. The board 210 may notify the doorbell press event by sending a message directly or indirectly via notification provider (e.g., via the doorbell security system notification server or Holovision notification server) to an Apple Push Notification service (APNS) server. The APNS server, in turn, may notify an iOS 3 device 220 installed with the application. A prior connection may need to exist between the board 210 and the APNS server and also between the APNS server and the iOS 3 device 220 for this notification mechanism to function correctly. The video (in H.264 or MJPEG format) may be transmitted over HTTP from the board to the iOS 3 device 220. The audio (in 16-bit PCM, AMR or AAC formats) communication between the board 210 and the iOS 3 device 220 may be established by the Session Initiation Protocol (SIP) when the application starts up. The iOS 3 device 220 may send a control signal to lock/unlock the door by transmitting data securely over TCP/IP to the board 210.

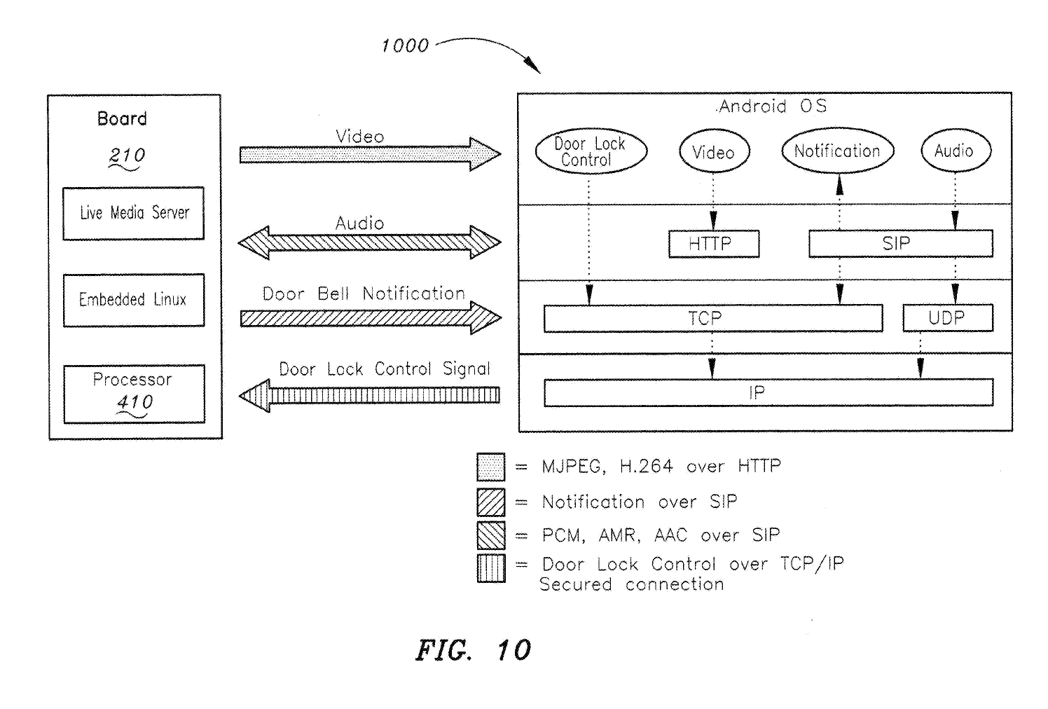

Referring to FIG. 10, a suitable software architecture 1000 diagram of an embodiment of the present invention configured to support Android is depicted. Embodiments of the present invention may include system architecture configured to support a native application on Google Android. The doorbell press event may be notified by transmitting data over the SIP connection between the board 210 and the registered Android device 220 (which may be running the application in the background). The SIP connection may be established when the Android device is powered on by starting the application and running it in the background. The video (in H.264 or MJPEG format) may be transmitted over HTTP or RTP/RTSP from the board 210 to the Android device 220. The audio (in 16-bit PCM, AMR or AAC formats) communication between the board 210 and the Android device 220 may be established by the Session Initiation Protocol (SIP). The Android device 220 may send a control signal to lock/unlock the door by transmitting data securely over TCP/IP to the board.

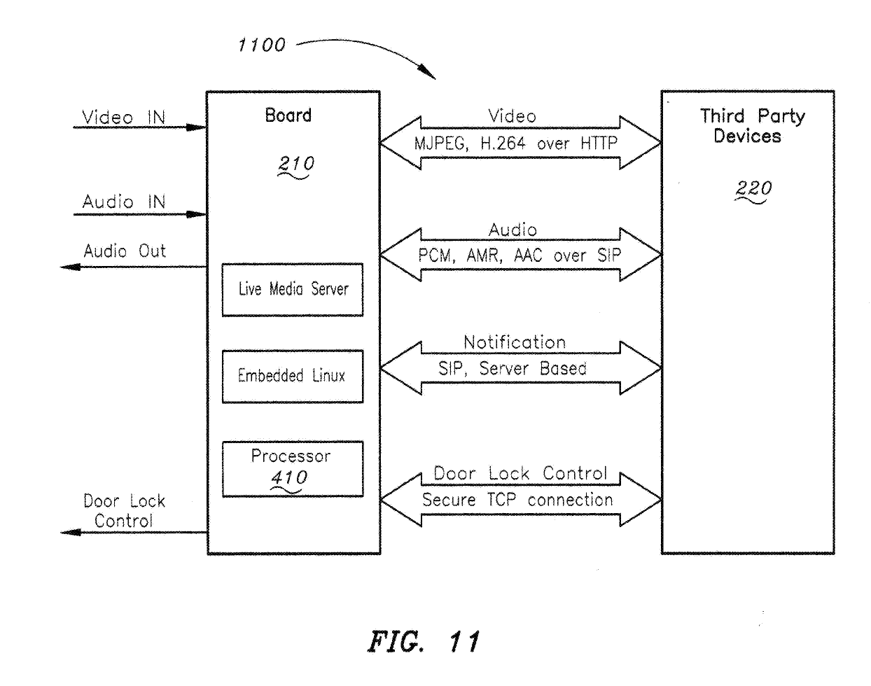

Referring to FIG. 11, a suitable software architecture 1100 diagram of embodiments of the present invention configured for supporting third party devices 220 is depicted. Embodiments of the present invention may include system architecture configured to support a native application on third party platforms. The intended system architecture to support a native application on third party platforms is depicted in FIG. 11 and is similar to the architecture depicted in FIG. 10 (and described above) for Android devices.

Embodiments of the present invention include a number of different press event notification configurations or options. When the doorbell 230 is pressed, the board 210 may attempt to notify the registered or associated mobile computing device 220 even if the mobile computing device 220 is not running. Different options or configurations can be implemented for event notifications on different platforms.

For example, iOS 4 may provide multitasking support for VOIP applications. The application may be a VOIP application requiring background run support from the operating system. When the application terminates, the operating system may take responsibility of monitoring the application's sockets tagged for VOIP communications. Whenever some data arrives on the tagged sockets, the operating system may alert the user. This capability may be used to send data when a doorbell press event occurs.

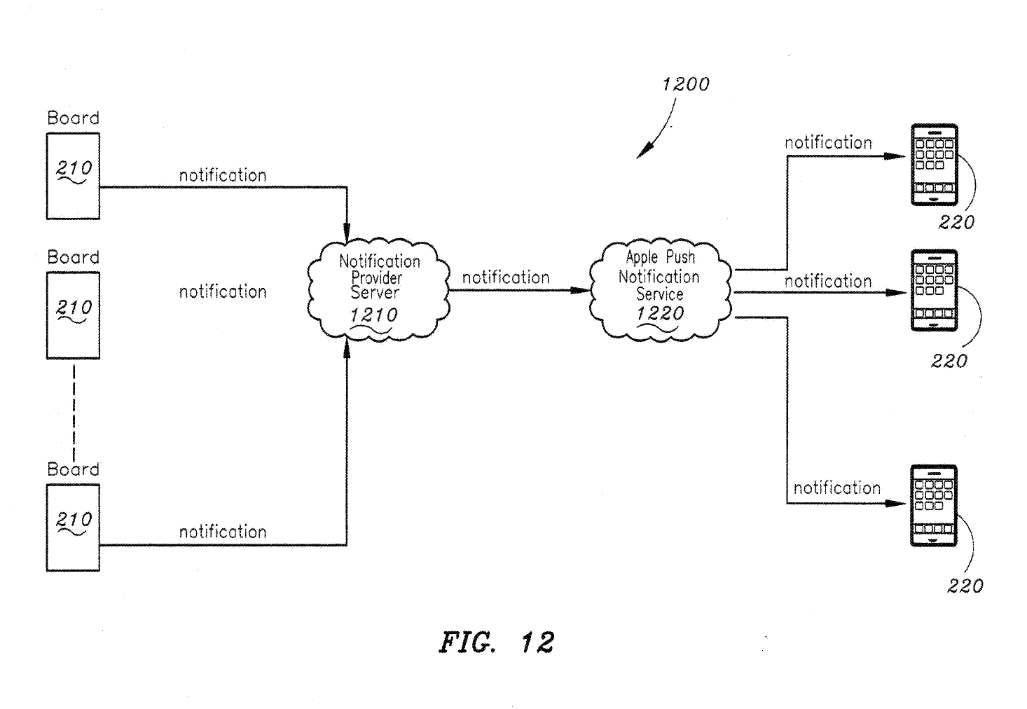

Referring to FIG. 12, a diagram of a notification system 1200 for iPhone 3 platforms is depicted. iOS 3 does not provide multitasking support. As a result, the Apple Push Notification Service (APNS) may be used. This approach may require a notification provider server (e.g., Holovision application server) that is registered as a “provider” for a specific application with Apple. The application and the mobile computing device 220 that is running application may also need to be registered with Apple. This mechanism is detailed in the FIG. 12. Single or multiple boards 210 may generate notifications when they sense the doorbell press event. These notifications may be communicated to the notification provider server (e.g., Holovision server), which in turn may notify the APNS server. The APNS may take responsibility of forwarding the notifications to the concerned mobile computing devices 220. When a device 220 receives a push notification, it may alert the user.

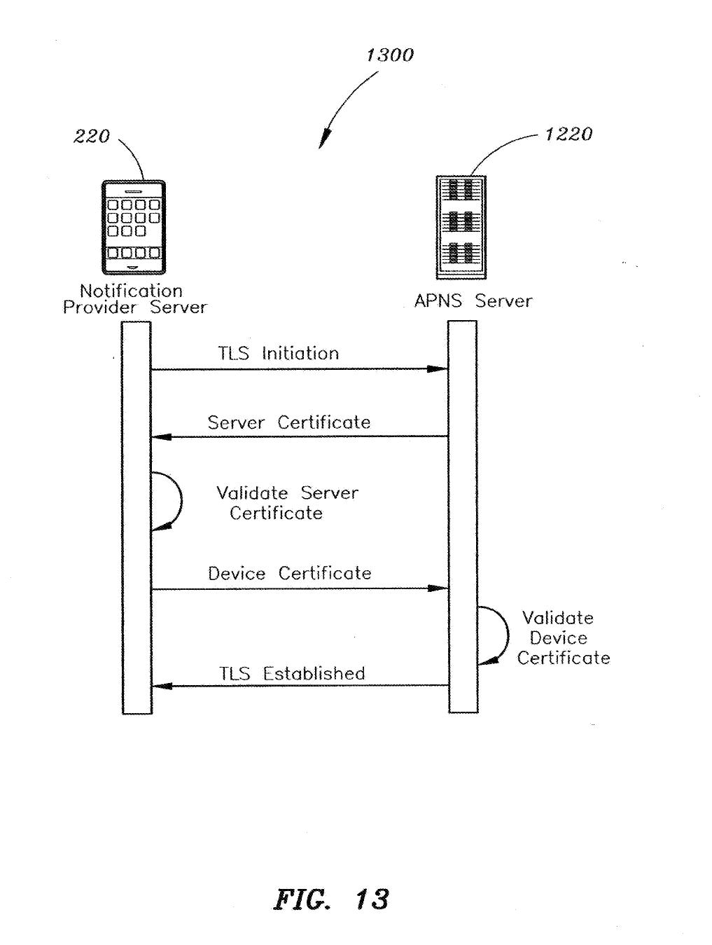

Referring to FIG. 13, a diagram of a device communicating 1300 with an APNS Server is depicted. Embodiments of the invention may implement a Device-To-Service Connection trust. When an iOS device 220 is switched on, it may initiate a TLS/SSL connection with Apple's APNS server. The server may respond with its certificate. This certificate may then be validated by the device 220 which may send back its device certificate. This certificate may be validated by the APNS server for device legitimacy and a connection may be established between the two parties.

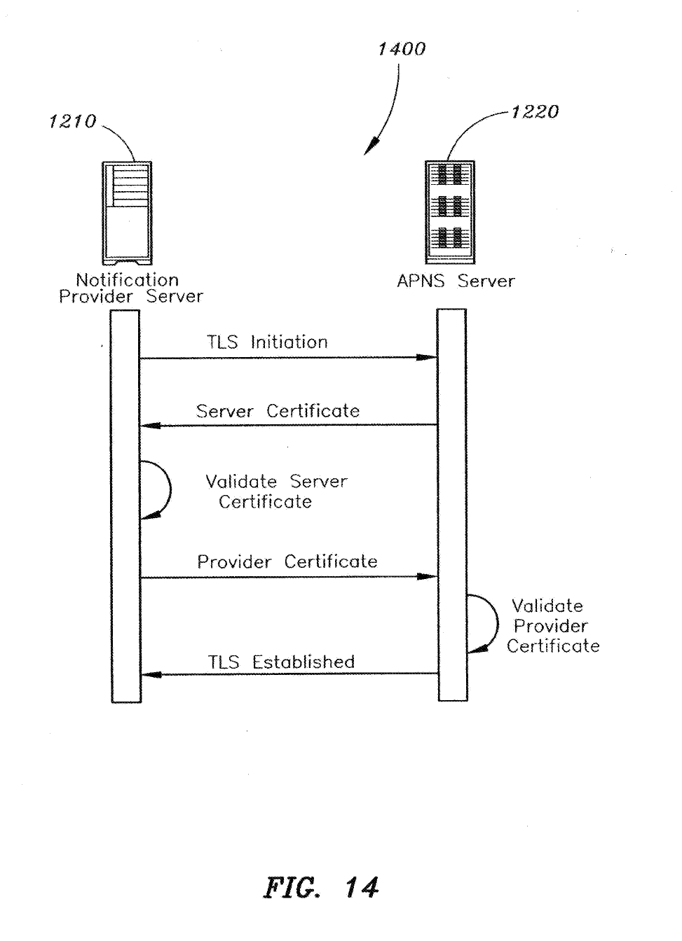

Referring to FIG. 14, a further diagram of a device communicating 1400 with an APNS server is depicted. Embodiments of the invention may implement a Provider-To-Service Connection trust. When the provider, such as notification provider server (e.g., a Holovision server), is powered on, it may initiate a TLS/SLL connection with Apple's APNS server which may respond with its server certificate. The provider may validate this certificate and may respond back with its provider certificate which may be validated by the APNS server for provider legitimacy and a persistent connection may be established.

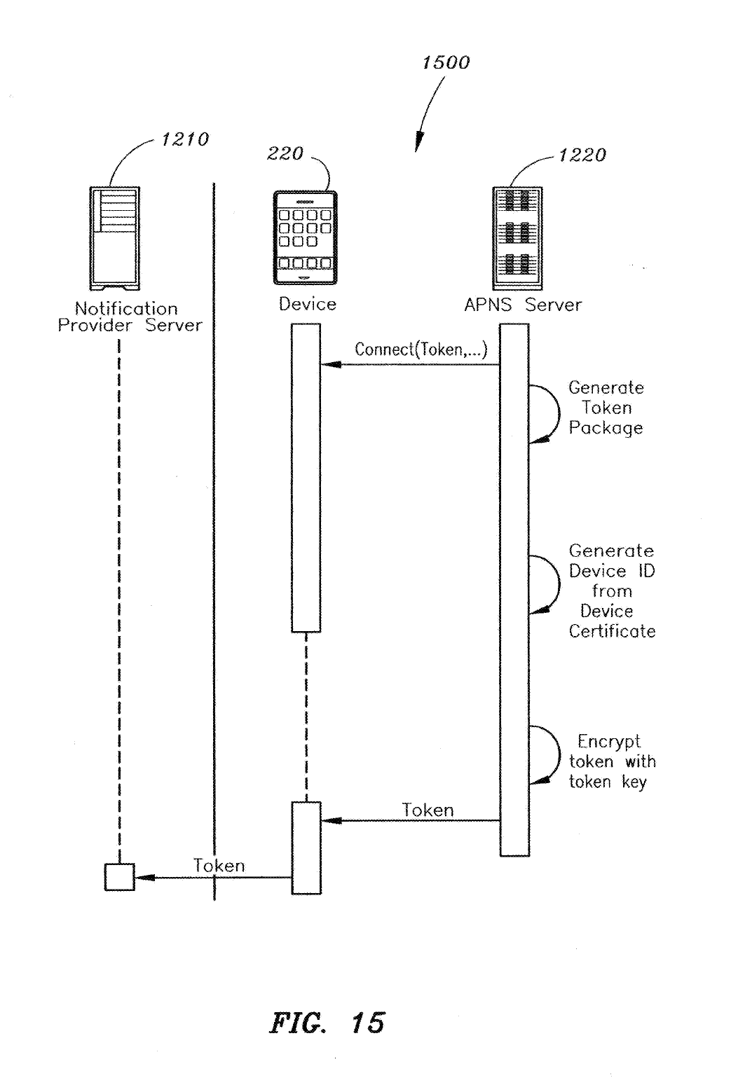

Referring to FIG. 15, a diagram of a device communicating 1500 with an APNS server is additionally depicted. Embodiments of the invention may implement a Token Generation and Dispersal. When an application is installed on an iOS device 220, it may register with the APNS server to get push notifications. It may send a registration request to the operating system which may forward it to the APNS server. The token passed may contain a device ID which is encrypted and returned to iOS by the APNS server. This token may then be passed to the application which forwards the same to the provider.

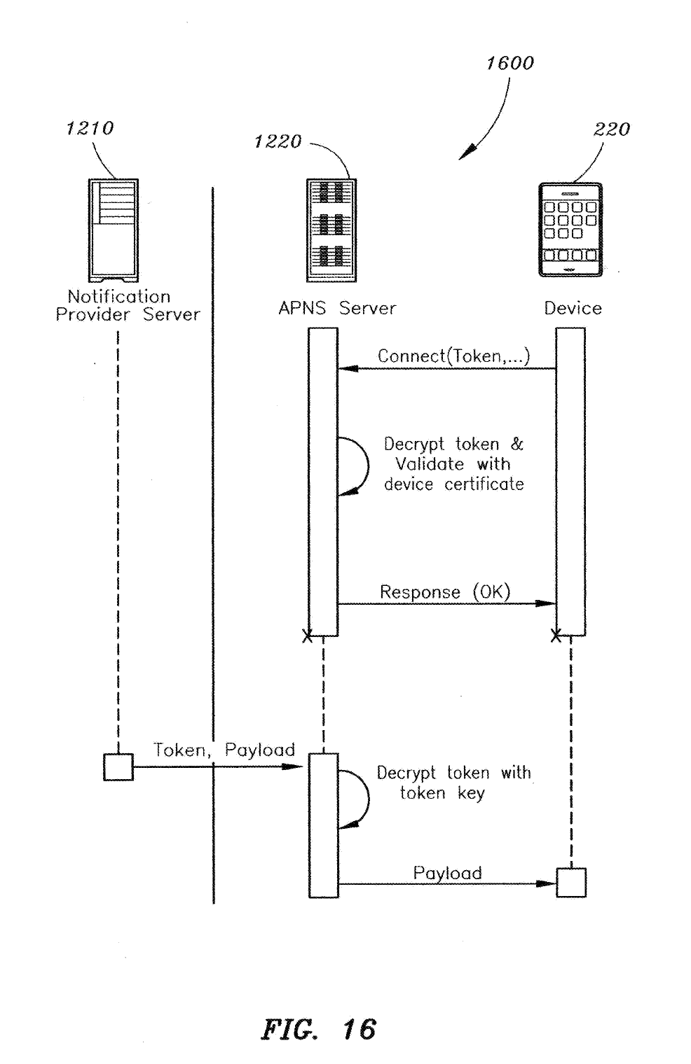

Referring to FIG. 16, a diagram of a secured token communication 1600 is depicted. Every time an iOS device 220 intends to connect with the APNS server, it may be required to provide the token received during registration. This token may be decrypted and validated with device certificate by the APNS server. Whenever the provider wants to send a push notification, the device token obtained from the application should also be sent. The APNS server may decrypt the token with the token key to establish the validity of the notification. Then, the device may be identified from the device ID in the token and the notification may be sent.

In some embodiments configured for Android devices 220, the Android platform may provide multitasking support. The application may run in the background listening on its VOIP socket. Whenever some data arrives on the VOIP socket, the operating system may alert the user. This capability may be used to send data when a doorbell press event occurs. The application may be brought to the foreground when a data packet is detected. Additionally, Google's Cloud to Device Messaging framework (C2DM) may be used.

In embodiments configured for third party devices, if a platform provides support for multitasking, the application may run in the background as described above for the Android platform. If a platform does not provide support for multitasking, the product may use a mechanism similar to Apple's Push Notification Service mechanism (if available), as described above.

Embodiments of the doorbell security system may include video transmission. The video captured by the camera of the doorbell unit 230 may be transmitted over the network. The video format used may depend on the capability of the smart phone/device to display such a video in real-time or substantially real-time. Different options are available depending on the different platforms of various mobile computing devices 220.

For iOS 4/iOS 3 mobile computing devices 220, video transmission may include MJPEG over HTTP or H.264 video content delivered by using RTP/HTTP tunneling. For MJPEG over HTTP, the video view port on the screen of the iOS 4/iOS 3 mobile computing device 220 may be a web browser control. When the application starts, an HTTP request may be sent to the board 210 which may respond with the web page containing a video frame (first in a sequence of digital video frames) compressed as a JPEG image. The sequence of JPEGs may be streamed from the board 210 over HTTP using a special mime-type which informs the browser control to expect the response in several parts. This process creates the effect of a motion picture. The connection may remain open as long as the browser control wants to receive new frames and the board wants to send new frames. For H.264 video content delivered using RTP/HTTP tunneling, a H.264 over HTTP using progressive download mechanism may be used. The progressive download mechanism may create short video files on the board storage which may progressively downloaded by the video player control in the mobile computing device application. Additionally, an H.264 over HTTP using HTTP Live streaming mechanism may be used. For the H.264 over HTTP using HTTP Live streaming mechanism, includes automatically switching to lower qualities when faced with lower bandwidths.

For Android or third party platforms video transmission may include MJPEG over HTTP or H.264 over RTP/RTSP or HTTP protocols. For MJPEG over HTTP, the video view port on the screen of the iOS 4/iOS 3 mobile computing device 220 may be a web browser control. When the application starts, an HTTP request may be sent to the board 210 which may respond with the web page containing a video frame (first in a sequence of digital video frames) compressed as a JPEG image. The sequence of JPEGs may be streamed from the board 210 over HTTP using a special mime-type which informs the browser control to expect the response in several parts. This process creates the effect of a motion picture. The connection may remain open as long as the browser control wants to receive new frames and the board wants to send new frames. For H.264 over RTP/RTSP or HTTP protocols, the video view port on the screen may be a media player control. When the application starts, the media player may start downloading and playing the video file specified by a URL that points to the location where the board is continuously creating short video files from the camera output. The files may be downloaded and played one after the other in a sequence.

Embodiments of the doorbell security system 200 may include several doorbell commands. Doorbell commands may include opening, closing, unlocking, or locking a door or the like. The doorbell commands may be transmitted over an IP Link. A separate TCP/IP session may be established to send commands from the recipient mobile computing device 220 to the board 210. This communication may be secured using SSL or other secured mechanisms to prevent unauthorized programs from issuing commands to open, close, unlock, or lock the door.

In some implementations of embodiments of the present invention, the present invention may be configured such that the doorbell notification latency may be limited to within a few seconds (e.g., 0.5 seconds, 1 second, 3 seconds, 10 seconds, or the like). Additionally, embodiments of the present invention may be configured such that the audio/video communication latency may be within a few seconds (e.g., 0.05 seconds, 0.1 seconds, 0.5 seconds, 1 second, 3 seconds, 10 seconds, or the like).

Embodiments of the present invention may be configured to send multiple outgoing connections from the board 210 to Smartphone applications. It is contemplated that one or more mobile computing devices may be paired with the board 210. For each device 220 an active SIP connection may need to be maintained for doorbell notifications for iOS4 or Android platforms.

Embodiments of the invention may be configured for multiple outgoing connections from a mobile computing device 220 to the board 210. Embodiments may be configured such that multiple doors may be controlled by one mobile computing device 220. For each connection, an active SIP connection may be maintained by iPhone/Android application. For example, board 210 to mobile computing device 220 connections may include any of the following cases: one-to-one connection between the board 210 and a mobile computing device application; many-to-one connection between the board and the mobile computing device application; one-to-many connection between the Board and mobile computing device application; and Many-to-Many connection between the board 210 and mobile computing device application.

Some embodiments of the doorbell security system 200 may be configured to be implemented with existing video door phones (such as a Holovision door phone). Other embodiments of the present invention may include modification or upgrade systems, kits, methods, or software to upgrade an existing video door phone to include features of the present invention.

In some embodiments, the doorbell security system 200 may include a mobile computing device running an SIP server. These embodiments may include communicating audio, video, and/or notifications over an SIP connection through the SIP server running on the mobile computing device. In some implementations, the SIP server may be running on a mobile computing device such as a tablet computing device (e.g., an iPad, Android tablet, or the like). The SIP server running on the mobile computing device may be configured to maintain one or more SIP connections between a mobile computing device 220 and the doorbell security system board 210. For example, the SIP server mobile computing device may be located within a household equipped with the doorbell security system 200. In other implementations, the SIP server mobile computing device may be located remotely from a location of the doorbell security system. Running the SIP server on a mobile computing device can provide heightened security for the doorbell security system 200 and increased control over data connections of the doorbell security system 200. When a visitor presses the doorbell, a notification signal may be sent from the doorbell 230 to the board 210 of the doorbell security system 200. The board 210 may then send an event notification to the SIP server running on the mobile computing device, and the SIP server running on the mobile computing device may relay the notification to another mobile computing device 220 where a user can respond to the notification. Additionally, audio and/or video may be communicated between the board 210 and the other mobile computing device 220 via the SIP connection through the SIP server of the mobile computing device.

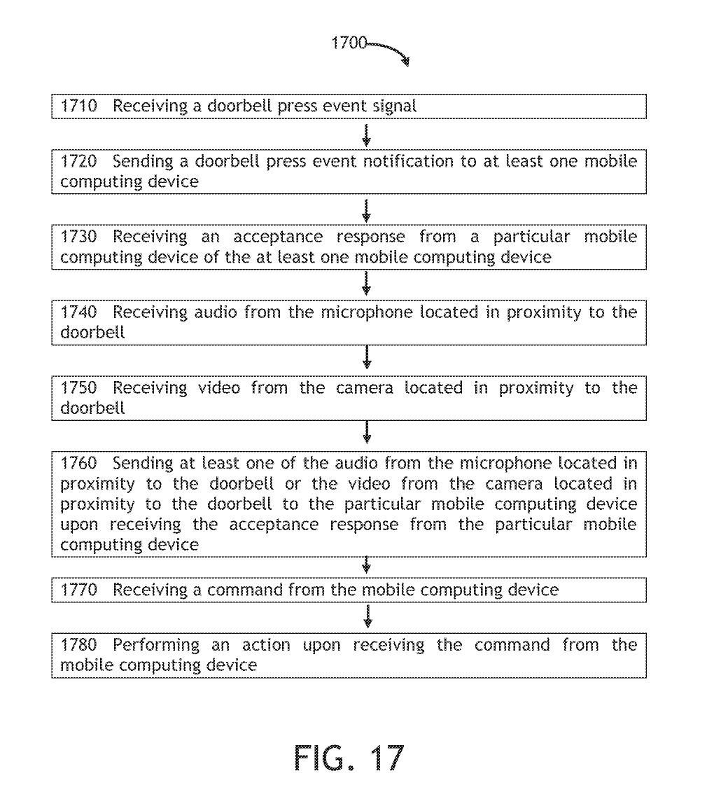

Referring to FIG. 17, an embodied method 1700 for operating a doorbell security system 200 is depicted. It is contemplated that embodiments of the method 1700 may be performed by one or more controllers, one or more processors, software, firmware executed on a computing device (such as a processor) of the doorbell security system board 210, other computing devices, other computer components, or on other software, firmware, or middleware. The method 1700 may include any or all of steps 1710, 1720, 1730, 1740, 1750, 1760, 1770, or 1780, and it is contemplated that the method 1700 may include additional steps as disclosed throughout, but not explicitly set forth in this paragraph. Further, it is fully contemplated that the steps of method 1700 may be performed concurrently or in a non-sequential order.

The method 1700 may include a step 1710, wherein the step 1710 may include receiving a doorbell press event signal. The method 1700 may include a step 1720, wherein the step 1720 may include sending a doorbell press event notification to at least one mobile computing device. The method 1700 may include a step 1730, wherein the step 1730 may include receiving an acceptance response from a particular mobile computing device of the at least one mobile computing device. The method 1700 may include a step 1740, wherein the step 1740 may include receiving audio from the microphone located in proximity to the doorbell. The method 1700 may include a step 1750, wherein the step 1750 may include receiving video from the camera located in proximity to the doorbell. The method 1700 may include a step 1760, wherein the step 1760 may include sending at least one of the audio from the microphone located in proximity to the doorbell or the video from the camera located in proximity to the doorbell to the particular mobile computing device upon receiving the acceptance response from the particular mobile computing device. The method 1700 may include a step 1770, wherein the step 1770 may include receiving a command from the mobile computing device. The method 1700 may include a step 1780, wherein the step 1780 may include performing an action upon receiving the command from the mobile computing device.

It is believed that the present invention and many of its attendant advantages will be understood by the foregoing description, and it will be apparent that various changes may be made in the form, construction, and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for operating a doorbell security system, the method comprising:
receiving a doorbell press event signal;
sending a doorbell press event notification to at least one mobile computing device;
receiving an acceptance response from a particular mobile computing device of the at least one mobile computing device, the acceptance response indicating that a user of the particular mobile device has requested to receive at least one of audio of a microphone or video of a camera, wherein the microphone is located in proximity to a doorbell and the camera is located in proximity to the doorbell;
receiving audio from the microphone located in proximity to the doorbell;
receiving video from the camera located in proximity to the doorbell;
sending at least one of the audio from the microphone located in proximity to the doorbell or the video from the camera located in proximity to the doorbell to the particular mobile computing device upon receiving the acceptance response from the particular mobile computing device;
receiving a command from the mobile computing device; and
performing an action upon receiving the command from the mobile computing device.

2. The method of claim 1, wherein the particular mobile computing device comprises a smart phone device.

3. The method of claim 1, further comprising:
at least one of digitizing or compressing at least one of the audio of the microphone or the video of the camera.

4. The method of claim 1, further comprising:
receiving audio from the particular mobile computing device; and
sending audio from the particular mobile computing device to a speaker located in proximity to the doorbell.

5. The method of claim 4, further comprising:
receiving video from the particular mobile computing device; and
sending video from the particular mobile computing device to a display located in proximity to the doorbell.

6. The method of claim 1, wherein audio and video is configured to be communicated substantially in real-time.

7. The method of claim 1, wherein performing an action upon receiving the command from the particular mobile computing device further comprises:
sending at least one signal to at least one relay configured to activate at least one of a door lock mechanism or a door opener/closer mechanism upon receiving the command from the particular mobile computing device, wherein the door lock mechanism is configured to unlock or lock a door and the door opener/closer mechanism is configured to open or close the door.

8. The method of claim 1, wherein receiving an acceptance response from a particular mobile computing device of the at least one mobile computing device, the acceptance response indicating that a user of the particular mobile device has requested to receive at least one of audio of a microphone or video of a camera, wherein the microphone is located in proximity to the doorbell and the camera is located in proximity to the doorbell further comprises:
receiving an acceptance response from a particular mobile computing device of the at least one mobile computing device, the acceptance response indicating that a user of the particular mobile device has requested to receive audio of a microphone and video of a camera, wherein the microphone is located in proximity to the doorbell and the camera is located in proximity to the doorbell.

9. The method of claim 1, further comprising:
establishing an SIP (session initiation protocol) connection.

10. The method of claim 1, further comprising:
establishing a two-way audio channel via an SIP (session initiation protocol) connection between the particular mobile computing device and a board of the doorbell security system.

11. The method of claim 1, further comprising:
establishing an SIP (session initiation protocol) connection through an SIP server, wherein the SIP server runs on a mobile computing device.

12. The method of claim 1, further comprising:
establishing an SIP (session initiation protocol) connection through an SIP server, wherein the SIP server runs on a tablet computing device.

13. A doorbell security system, comprising:
a doorbell security system board, wherein the doorbell security system board is configured for:
receiving a doorbell press event signal;
sending a doorbell press event notification to at least one mobile computing device;
receiving an acceptance response from a particular mobile computing device of the at least one mobile computing device, the acceptance response indicating that a user of the particular mobile device has requested to receive at least one of audio of a microphone or video of a camera, wherein the microphone is located in proximity to a doorbell and the camera is located in proximity to the doorbell;
receiving audio from the microphone located in proximity to the doorbell;
receiving video from the camera located in proximity to the doorbell;
sending at least one of the audio from the microphone located in proximity to the doorbell or the video from the camera located in proximity to the doorbell to the particular mobile computing device upon receiving the acceptance response from the particular mobile computing device;
receiving a command from the mobile computing device; and
performing an action upon receiving the command from the mobile computing device.

14. The doorbell security system of claim 13, wherein the doorbell security system board is further configured for:
receiving audio from the particular mobile computing device; and
sending audio from the particular mobile computing device to a speaker located in proximity to the doorbell.

15. The doorbell security system of claim 13, wherein audio and video is configured to be communicated substantially in real-time.

16. The doorbell security system of claim 13, wherein the doorbell security system board is further configured for:
sending at least one signal to at least one relay configured to activate at least one of a door lock mechanism or a door opener/closer mechanism upon receiving the command from the particular mobile computing device, wherein the door lock mechanism is configured to unlock or lock a door and the door opener/closer mechanism is configured to open or close the door.

17. The doorbell security system of claim 13, wherein the doorbell security system board is further configured for:
establishing an SIP (session initiation protocol) connection.

18. The doorbell security system of claim 13, wherein the doorbell security system board is further configured for:
establishing a two-way audio channel via an SIP (session initiation protocol) connection between the particular mobile computing device and a board of the doorbell security system.

19. The doorbell security system of claim 13, wherein the doorbell security system board is further configured for:
establishing an SIP (session initiation protocol) connection through an SIP server, wherein the SIP server runs on a mobile computing device.

20. A doorbell security system, comprising:
a doorbell security system board, wherein the doorbell security system board is configured for:
receiving a doorbell press event signal;
sending a doorbell press event notification to at least one mobile computing device;
receiving an acceptance response from a particular mobile computing device of the at least one mobile computing device, the acceptance response indicating that a user of the particular mobile device has requested to receive audio of a microphone and video of a camera, wherein the microphone is located in proximity to the doorbell and the camera is located in proximity to the doorbell;
establishing a two-way audio channel via an SIP (session initiation protocol) connection through an SIP server, wherein the SIP server runs on another mobile computing device between the particular mobile computing device and the doorbell security system board;
receiving audio from the microphone located in proximity to the doorbell;
receiving video from the camera located in proximity to the doorbell;
sending the audio from the microphone located in proximity to the doorbell to the particular mobile computing device upon receiving the acceptance response from the particular mobile computing device;
sending the video from the camera located in proximity to the doorbell to the particular mobile computing device upon receiving the acceptance response from the particular mobile computing device;
receiving audio from the particular mobile computing device; and
sending audio from the particular mobile computing device to a speaker located in proximity to the doorbell;
receiving a command from the mobile computing device; and
sending at least one signal to at least one relay configured to activate at least one of a door lock mechanism or a door opener/closer mechanism upon receiving the command from the particular mobile computing device, wherein the door lock mechanism is configured to unlock or lock a door and the door opener/closer mechanism is configured to open or close the door,
wherein audio and video is configured to be communicated substantially in real-time.
